(19) United States
(12) Patent Application Publication
(10) Pub. No.: US 2013/0287109 A1
(43) Pub. Date: Oct. 31, 2013

(54) INTER-LAYER PREDICTION THROUGH TEXTURE SEGMENTATION FOR VIDEO CODING

(71) Applicant: QUALCOMM INCORPORATED, San Diego, CA (US)

(72) Inventors: Xianglin WANG, San Diego, CA (US); Marta KARCZEWICZ, San Diego, CA (US)

(73) Assignee: QUALCOMM Incorporated, San Diego, CA (US)

(21) Appl. No.: 13/869,592

(22) Filed: Apr. 24, 2013

Related U.S. Application Data
(60) Provisional application No. 61/639,931, filed on Apr. 29, 2012.
(60) Provisional application No. 61/640,457, filed on Apr. 30, 2012.
(60) Provisional application No. 61/707,205, filed on Sep. 28, 2012.

(51) Int. Cl. H04N 7/50

(52) U.S. Cl. CPC H04N 19/00781
USPC 375/240.16

(57) ABSTRACT

An apparatus for coding video data according to certain aspects includes a memory and a processor in communication with the memory. The memory stores the video data. The video data may include a base layer and an enhancement layer, the base layer including a base layer block and the enhancement layer including an enhancement layer block. The base layer block may be located at a position in the base layer corresponding to a position of the enhancement layer block in the enhancement layer. The processor determines, based on information associated with the base layer block, a partitioning mode of the enhancement layer block. The partitioning mode may indicate that the enhancement layer block is to be partitioned into a first partition and a second partition. The processor further performs motion compensation for the first partition and the second partition of the enhancement layer block.

### CROSS-REFERENCE TO RELATED APPLICATIONS

This application claims priority under 35 U.S.C. §119(e) to U.S. Provisional Application No. 61/639,931, entitled “INTER-LAYER PREDICTION THROUGH TEXTURE SEGMENTATION FOR VIDEO CODING” and filed on Apr. 29, 2012, to U.S. Provisional Patent Application No. 61/640,457, entitled “INTER-LAYER PREDICTION THROUGH TEXTURE SEGMENTATION FOR VIDEO CODING” and filed on Apr. 30, 2012, and to U.S. Provisional Patent Application No. 61/707,205, entitled “INTER-LAYER PREDICTION THROUGH TEXTURE SEGMENTATION FOR VIDEO CODING” and filed on Sep. 28, 2012, each of which are hereby incorporated by reference in their entireties.

### TECHNICAL FIELD

This disclosure relates to video coding and compression and, in particular, to scalable video coding (SVC).

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information by implementing such video coding techniques.

Video compression techniques perform spatial (intra-picture) prediction and/or temporal (inter-picture) prediction to reduce or remove redundancy inherent in video sequences. For block-based video coding, a video slice (e.g., a video frame, a portion of a video frame, etc.) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which may be quantized. The quantized transform coefficients may be initially arranged in a two-dimensional array and scanned in order to produce a one-dimensional vector of transform coefficients, and entropy coding may be applied to achieve even more compression.

### SUMMARY

In general, this disclosure describes techniques related to scalable video coding (SVC). One aspect of the disclosure provides a method for decoding video data. The method comprises receiving syntax elements extracted from an encoded video bit stream. The syntax elements may comprise information associated with a base layer block of a base layer of the video data. The method further comprises determining, based on the information associated with the base layer block, a partitioning mode of an enhancement layer block of an enhancement layer of the video data. The base layer block may be located at a position in the base layer corresponding to a position of the enhancement layer block in the enhancement layer. The partitioning mode may indicate that the enhancement layer block is to be partitioned into a first partition and a second partition. Pixels of the base layer block may be classified into the first partition if a value of the respective pixel exceeds a threshold and may be classified into the second partition if a value of the respective pixel does not exceed the threshold. The method further comprises performing motion compensation for the first partition and the second partition of the enhancement layer block.

Another aspect of the disclosure provides a method for encoding video data. The method comprises receiving information associated with a base layer block of a base layer of the video data. The method further comprises determining, based on the information associated with the base layer block, a partitioning mode of an enhancement layer block of an enhancement layer of the video data. The base layer block may be located at a position in the base layer corresponding to a position of the enhancement layer block in the enhancement layer. The partitioning mode may indicate that the enhancement layer block is to be partitioned into a first partition and a second partition. Pixels of the base layer block may be classified into the first partition if a value of the respective pixel exceeds a threshold and may be classified into the second partition if a value of the respective pixel does not exceed the threshold. The method further comprises performing motion compensation for the first partition and the second partition of the enhancement layer block.

Another aspect of the disclosure provides an apparatus configured to code video data. The apparatus comprises a memory configured to store the video data. The video data may comprise a base layer and an enhancement layer. The base layer may comprise a base layer block. The enhancement layer may comprise an enhancement layer block. The base layer block may be located at a position in the base layer corresponding to a position of the enhancement layer block in the enhancement layer. The apparatus further comprises a processor in communication with the memory, the processor configured to determine, based on information associated with the base layer block, a partitioning mode of the enhancement layer block. The partitioning mode may indicate that the enhancement layer block is to be partitioned into a first partition and a second partition. Pixels of the base layer block may be classified into the first partition if a value of the respective pixel exceeds a threshold and may be classified into the second partition if a value of the respective pixel does not exceed the threshold. The processor may be further configured to perform motion compensation the first partition and the second partition of the enhancement layer block.

Another aspect of the disclosure provides a non-transitory computer readable medium comprising code that, when executed, causes an apparatus to determine, based on information associated with a base layer block of a base layer of video data, a partitioning mode of an enhancement layer block of an enhancement layer of the video data. The base layer block may be located at a position in the base layer corresponding to a position of the enhancement layer block in the enhancement layer. The partitioning mode may indicate that the enhancement layer block is to be partitioned into a first partition and a second partition. Pixels of the base layer block may be classified into the first partition if a value of the respective pixel exceeds a threshold and may be classified into the second partition if a value of the respective pixel does not exceed the threshold. The medium further comprises code that, when executed, causes an apparatus to perform motion compensation for the first partition and the second partition of the enhancement layer block.

Another aspect of the disclosure provides a video coding device that codes video data. The video coding device may comprise means for determining, based on information associated with a base layer block of a base layer of the video data, a partitioning mode of an enhancement layer block of an enhancement layer of the video data. The base layer block may be located at a position in the base layer corresponding to a position of the enhancement layer block in the enhancement layer. The partitioning mode may indicate that the enhancement layer block is to be partitioned into a first partition and a second partition. Pixels of the base layer block may be classified into the first partition if a value of the respective pixel exceeds a threshold and may be classified into the second partition if a value of the respective pixel does not exceed the threshold. The video coding device may further comprise means for performing motion compensation for the first partition and the second partition of the enhancement layer block.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may utilize techniques in accordance with aspects described in this disclosure.

FIG. 2 is a block diagram illustrating an example of a video encoder that may implement techniques in accordance with aspects described in this disclosure.

FIG. 3 is a block diagram illustrating an example of a video decoder that may implement techniques in accordance with aspects described in this disclosure.

FIG. 4 is a conceptual diagram that illustrates example partitioning modes.

FIG. 5 is a block diagram of an example scalable video coding (SVC) encoder.

FIG. 6 is another conceptual diagram that illustrates example partitioning modes.

FIG. 7 is a flowchart illustrating an example method for coding video data according to aspects of this disclosure.

FIG. 8 is a flowchart illustrating an example method for decoding video data according to aspects of this disclosure.

FIG. 9 is a flowchart illustrating an example method for encoding video data according to aspects of this disclosure.

### DETAILED DESCRIPTION

The attached drawings illustrate examples. Elements indicated by reference numbers in the attached drawings correspond to elements indicated by like reference numbers in the following description. In this disclosure, elements having names that start with ordinal words (e.g., “first,” “second,” “third,” and so on) do not necessarily imply that the elements have a particular order. Rather, such ordinal words are merely used to refer to different elements of a same or similar type.

A digital image, such as a video image, a TV image, a still image or an image generated by a video recorder or a computer, may consist of pixels arranged in horizontal and vertical lines. The number of pixels in a single image is typically in the tens of thousands. Each pixel typically contains luminance and chrominance information. Without compression, the quantity of information to be conveyed from an image encoder to an image decoder is so enormous that it renders real-time image transmission impossible. To reduce the amount of information to be transmitted, a number of different compression methods, such as JPEG, MPEG and H.263 standards, have been developed.

The techniques described in this disclosure generally relate to scalable video coding (SVC) and 3D video coding. For example, the techniques may be related to, and used with or within, a High Efficiency Video Coding (HEVC) scalable video coding (SVC) extension. In an SVC extension, there could be multiple layers of video information. A layer at the very bottom level or lowest level may serve as a base layer (BL), and the layer at the very top may serve as an enhanced layer (EL). The “enhanced layer” is sometimes referred to as an “enhancement layer,” and these terms may be used interchangeably. Layers between the BL and EL may serve as either or both ELs or BLs. For example, a layer may be an EL for the layers below it, such as the base layer or any intervening enhancement layers, and also serve as a BL for the enhancement layers above it.

For purposes of illustration only, the techniques described in the disclosure are described using examples including only two layers. One layer can include a lower level layer or reference layer, and another layer can include a higher level layer or enhancement layer. For example, the reference layer can include a base layer or a temporal reference on an enhancement layer, and the enhancement layer can include an enhanced layer relative to the reference layer. It should be understood that the examples described in this disclosure can be extended to examples with multiple base layers and enhancement layers as well.

Generally, blocks in the frame of an image can be partitioned for compression purposes. For example, a block in a frame may be partitioned into one or more units that are individually compressed by an encoder. A decoder may then receive the compressed data and reconstruct each of the partitioned units of the block. In the context of multiple layers, a partition mode of a base layer block may be used to predict the partition mode of a current block at an enhancement layer. Such prediction of partition modes can be indicated through a flag sent from the encoder to the decoder for the block. When the flag has a certain value (e.g., one, etc.), the partition mode of a current block at the enhancement layer is derived based on the partition mode of its corresponding block at the base layer.

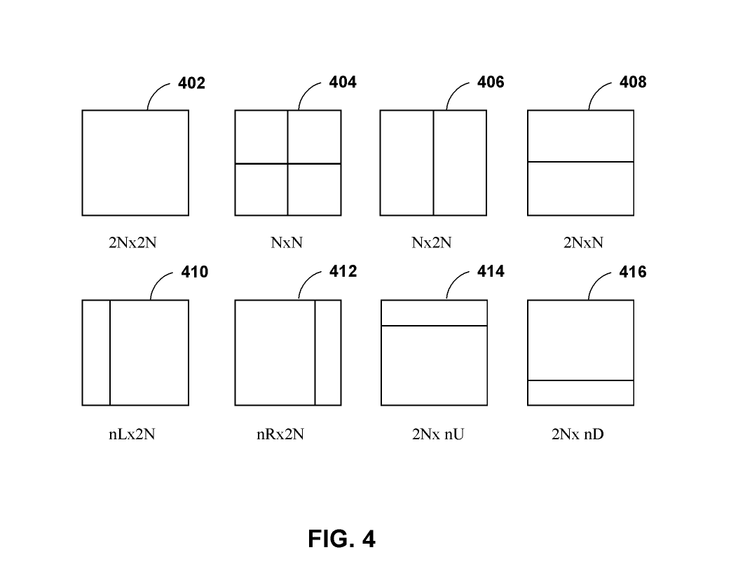

A partition may have a regular shape. As illustrated below in FIG. 4, the partition modes all have regular shape prediction units. For example, the prediction units are either square or rectangular. Using rectangular shape prediction units may have the advantage of lower complexity.

However, previous SVC coding schemes that use rectangular or square shape prediction units may result in a lower encoding and/or decoding efficiency. In particular, a rectangular or square shape prediction may not precisely match the actual shapes of objects in an image. For example, objects in an image may have irregular shapes. By not matching the actual shapes of objects in an image, the encoding and/or decoding efficiency may be reduced because a prediction unit may include a wide variety of pixel values. An encoder or decoder may increase encoding or decoding efficiency by identifying commonalities in the prediction unit, but there may be fewer commonalities in the prediction unit if there are a wide variety of pixel values in the prediction unit. Thus, a prediction unit that matched an actual shape of an object in an image and/or matched a portion, edge, or contour of an actual shape of an object in an image may increase the encoding and/or decoding efficiency.

Accordingly, aspects of an SVC coding scheme are described herein that may improve encoding and/or decoding efficiency. In accordance with the techniques of this disclosure, a partition of a current block at an enhancement layer is predicted or derived based on information of a base layer block that corresponds with the current block. Such information may include a partition mode of the base layer block, a reconstructed video texture of the base layer block, motion information of the base layer block, and/or the like. Furthermore, in accordance with the techniques of this disclosure, the derived partitions for a current block at the enhancement layer may not necessarily have regular shapes, such as a square or a rectangular. Instead, the partition shapes may be irregular if an object in an image has an irregular shape. In this way, the partition shapes may more closely match an actual shape of an object in an image.

In order to generate irregular partition shapes, the encoder and/or decoder may be configured to perform image segmentation. Image segmentation may include identifying segments or individual parts of an image based on a set of rules, which are described in greater detail below. The irregular partition shapes may be based on image segmentation of a base layer reconstructed texture, image segmentation of base layer prediction residual, and/or conditional enabling of image segmentation based partition derivation. Such techniques are described in greater detail below with respect to FIGS. 4-8.

In general, video coding standards can include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its SVC and Multiview Video Coding (MVC) extensions. A draft of MVC is described in “Advanced video coding for generic audiovisual services,” ITU-T Recommendation H.264, March 2010. In addition, HEVC is currently being developed by the Joint Collaboration Team on Video Coding (JCT-VC) of ITU-T Video Coding Experts Group (VCEG) and ISO/IEC Motion Picture Experts Group (MPEG). A recent draft of HEVC is available from http://wg11.sc29.org/jct/doc_end_user/current_document.php?id=5885/JCTVC-I1003-v2, as of Jun. 7, 2012. Another recent draft of the HEVC standard, referred to as “HEVC Working Draft 7” is downloadable from http://phenix.it-sudparis.eu/jct/doc_end_user/documents/9_Geneva/wg11/JCTVC-I1003-v3.zip, as of Jun. 7, 2012. The full citation for the HEVC Working Draft 7 is document HCTVC-I1003, Bross et al., “High Efficiency Video Coding (HEVC) Text Specification Draft 7,” Joint Collaborative Team on Video Coding (JCT-VC) of ITU-T SG16 WP3 and ISO/IEC JTC1/SC29/WG11, 9^{th} Meeting: Geneva, Switzerland, Apr. 27, 2012 to May 7, 2012. Each of these references is herein incorporated by reference in its entirety.

SVC may be used to provide quality (also referred to as signal-to-noise (SNR)) scalability, spatial scalability (e.g., resolution scaling), and/or temporal scalability (e.g., frame rate scaling). An enhanced layer may have a different spatial resolution than a base layer. For example, the spatial aspect ratio between EL and BL can be 1.0, 1.5, 2.0, or other different ratios. In other words, the spatial aspect of the EL may equal 1.0, 1.5, or 2.0 times the spatial aspect of the BL. In some examples, the scaling factor of the EL may be greater than the BL. For example, a size of pictures in the EL may be greater than a size of pictures in the BL. In this way, it may be possible, although not a limitation, that the spatial resolution of the EL is larger than the spatial resolution of the BL.

In SVC, prediction of a current block may be performed using the different layers that are provided for SVC. Such prediction may be referred to as inter-layer prediction. Inter-layer prediction methods may be utilized in SVC in order to reduce inter-layer redundancy. Some examples of inter-layer prediction may include inter-layer intra prediction, inter-layer motion prediction, and inter-layer residual prediction. Inter-layer intra prediction uses the reconstruction of co-located blocks in the base layer to predict the current block in the enhancement layer. As used herein, a co-located block in the base layer is a block located at a position in the base layer that corresponds with a position of the current block in the enhancement layer. Inter-layer motion prediction uses motion of the base layer to predict motion in the enhancement layer. Inter-layer residual prediction uses the residue of the base layer to predict the residue of the enhancement layer.

In inter-layer residual prediction, the residue of the base layer may be used to predict the current block in the enhancement layer. The residue may be defined as the difference between the temporal prediction for a video unit and the source video unit. In residual prediction, the residue of the base layer is also considered in predicting the current block. For example, the current block may be reconstructed using the residue from the enhancement layer, the temporal prediction from the enhancement layer, and the residue from the base layer. The current block may be reconstructed according to the following equation:

Îₑ=rₑ+Pₑ+r_{b} (1)

where Îₑ denotes the reconstruction of the current block, rₑ denotes the residue from the enhancement layer, Pₑ denotes the temporal prediction from the enhancement layer, and r_{b} denotes the residue prediction from the base layer.

In order to use inter-layer residual prediction for a macroblock (MB) in the enhancement layer, the co-located macroblock in the base layer should be an inter MB, and the residue of the co-located base layer macroblock may be upsampled according to the spatial resolution ratio of the enhancement layer (e.g., because the layers in SVC may have different spatial resolutions) relative to its base layer. In inter-layer residual prediction, the difference between the residue of the enhancement layer and the residue of the upsampled base layer may be coded in the bitstream. The residue of the base layer may be normalized based on the ratio between quantization steps of base and enhancement layers.

SVC extension to H.264 requires single-loop decoding for motion compensation in order to maintain low complexity for the decoder. In general, motion compensation is performed by adding the temporal prediction and the residue for the current block as follows:

Î=r+P (2)

where Î denotes the current frame, r denotes the residue, and P denotes the temporal prediction. In single-loop decoding, each supported layer in SVC can be decoded with a single motion compensation loop. In order to achieve this, all blocks that are used for inter-layer intra prediction are coded using constrained intra-prediction. In constrained intra prediction, intra mode MBs are intra-coded without referring to any samples from neighboring inter-coded MBs. On the other hand, HEVC allows multi-loop decoding for SVC, in which an SVC layer may be decoded using multiple motion compensation loops. For example, the base layer is fully decoded first, and then the enhancement layer is decoded.

Residual prediction formulated in Equation (1) may be an efficient technique in H.264 SVC extension. However, its performance can be further improved in HEVC SVC extension, especially when multi-loop decoding is used in HEVC SVC extension.

In the case of multi-loop decoding, difference domain motion compensation may be used in place of residual prediction. In SVC, an enhancement layer may be coded using pixel domain coding or difference domain coding. In pixel domain coding, the input pixels for an enhancement layer may be coded, as for a non-SVC HEVC layer. On the other hand, in difference domain coding, difference values for an enhancement layer may be coded. The difference values may be the difference between the input pixels for the enhancement layer and the corresponding scaled base layer reconstructed pixels. Such difference values may be used in motion compensation for difference domain motion compensation.

For inter coding using difference domain, the current predictive block is determined based on the difference values between the corresponding predictive block samples in the enhancement layer reference picture and the corresponding predictive block samples in the scaled base layer reference picture. The difference values may be referred to as the difference predictive block. The co-located base layer reconstructed samples are added to the difference predictive block in order to obtain enhancement layer reconstructed samples.

In some embodiments, the location of a co-located block in the base layer can be fixed and/or dependent on factors such as a largest coding unit (LCU), a coding unit (CU), a prediction unit (PU), and/or transform unit (TU) sizes. The LCU, CU, PU, and TU are described in greater detail below.

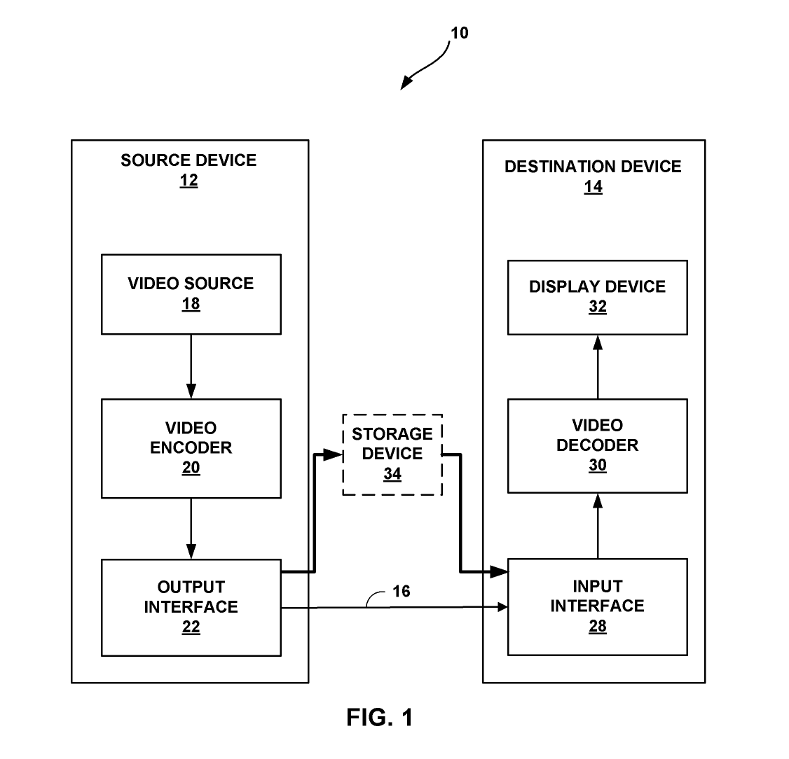

FIG. 1 is a block diagram that illustrates an example video coding system 10 that may utilize techniques in accordance with aspects described in this disclosure, such as partition derivation based on image segmentation. As used described herein, the term “video coder” refers generically to both video encoders and video decoders. In this disclosure, the terms “video coding” or “coding” may refer generically to video encoding and video decoding.

As shown in FIG. 1, video coding system 10 includes a source device 12 and a destination device 14. Source device 12 generates encoded video data. Destination device 14 may decode the encoded video data generated by source device 12. Source device 12 and destination device 14 may comprise a wide range of devices, including desktop computers, notebook (e.g., laptop, etc.) computers, tablet computers, set-top boxes, telephone handsets such as so-called “smart” phones, so-called “smart” pads, televisions, cameras, display devices, digital media players, video gaming consoles, in-car computers, or the like. In some examples, source device 12 and destination device 14 may be equipped for wireless communication.

Destination device 14 may receive encoded video data from source device 12 via a channel 16. Channel 16 may comprise any type of medium or device capable of moving the encoded video data from source device 12 to destination device 14. In one example, channel 16 may comprise a communication medium that enables source device 12 to transmit encoded video data directly to destination device 14 in real-time. In this example, source device 12 may modulate the encoded video data according to a communication standard, such as a wireless communication protocol, and may transmit the modulated video data to destination device 14. The communication medium may comprise a wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or other equipment that facilitates communication from source device 12 to destination device 14.

In another example, encoded data may be output from output interface 22 to an optional storage device 34. Similarly, encoded data may be accessed from the storage device 34 by input interface 28. The storage device 34 may include a variety of locally accessed data storage media, such as a hard drive, Blu-ray discs, DVDs, CD-ROMs, flash memory, volatile or non-volatile memory, or other suitable digital storage media for storing encoded video data. In a further example, the storage device 34 may correspond to a file server or another intermediate storage device that stores the encoded video generated by source device 12. In this example, destination device 14 may access encoded video data from the storage device 34 via streaming or download. The file server may be a type of server capable of storing encoded video data and transmitting the encoded video data to destination device 14. Example file servers include web servers (e.g., for a website, etc.), FTP servers, network attached storage (NAS) devices, and local disk drives. Destination device 14 may access the encoded video data through any standard data connection, including an Internet connection. Example types of data connections may include wireless channels (e.g., Wi-Fi connections, etc.), wired connections (e.g., DSL, cable modem, etc.), or combinations of both that are suitable for accessing encoded video data stored on a file server. The transmission of encoded video data from the storage device 34 may be a streaming transmission, a download transmission, or a combination of both.

The techniques of this disclosure are not limited to wireless applications or settings. The techniques may be applied to video coding in support of any of a variety of multimedia applications, such as over-the-air television broadcasts, cable television transmissions, satellite television transmissions, streaming video transmissions, e.g., via the Internet (e.g., dynamic adaptive streaming over HTTP (DASH), etc.), encoding of digital video for storage on a data storage medium, decoding of digital video stored on a data storage medium, or other applications. In some examples, video coding system 10 may be configured to support one-way or two-way video transmission to support applications such as video streaming, video playback, video broadcasting, and/or video telephony.

In the example of FIG. 1, source device 12 includes a video source 18, video encoder 20, and an output interface 22. In some cases, output interface 22 may include a modulator/demodulator (modem) and/or a transmitter. In source device 12, video source 18 may include a source such as a video capture device (e.g., a video camera), a video archive containing previously captured video data, a video feed interface to receive video data from a video content provider, and/or a computer graphics system for generating video data, or a combination of such sources. Video source 18 may generate computer graphics-based data as the source video, or a combination of live video, archived video, and computer-generated video. In some embodiments, if video source 18 is a video camera, source device 12 and destination device 14 may form so-called camera phones or video phones.

Video encoder 20 may be configured to encode the captured, pre-captured, or computer-generated video data. The encoded video data may be transmitted directly to destination device 14 via output interface 22 of source device 12. The encoded video data may also (or alternatively) be stored onto storage device 34 for later access by destination device 14 for decoding and/or playback. In other embodiments, a source device and a destination device may include other components or arrangements. For example, source device 12 may receive video data from an external video source 18, such as an external camera. Likewise, destination device 14 may interface with an external display device, rather than including an integrated display device.

In the example of FIG. 1, destination device 14 includes an input interface 28, a video decoder 30, and a display device 32. In some cases, input interface 28 may include a receiver and/or a modem. Input interface 28 of destination device 14 receives encoded video data over channel 16. The encoded video data communicated over channel 16, or provided on storage device 34, may include a variety of syntax elements generated by video encoder 20 that represent the video data and that can be used by video decoder 30. The syntax elements may describe characteristics and/or processing of blocks and other coded units (e.g., a group of pictures (GOPs)). Such syntax elements may be included with the encoded video data transmitted on a communication medium, stored on a storage medium, or stored in a file server.

Display device 32 may be integrated with or may be external to destination device 14. In some examples, destination device 14 may include an integrated display device and may also be configured to interface with an external display device. In other examples, destination device 14 may be a display device. In general, display device 32 displays the decoded video data to a user. Display device 32 may comprise any of a variety of display devices, such as a cathode ray tube (CRT), a liquid crystal display (LCD), a plasma display, a light emitting diode (LED) display, an organic light emitting diode (OLED) display, or another type of display device.

Video encoder 20 and video decoder 30 may operate according to a video compression standard, such as the HEVC standard presently under development, and may conform to the HEVC Test Model (HM). Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples of video compression standards include MPEG-2 and ITU-T H.263.

Although not shown in the example of FIG. 1, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

Again, FIG. 1 is merely an example and the techniques of this disclosure may apply to video coding settings (e.g., video encoding or video decoding) that do not necessarily include any data communication between the encoding and decoding devices. In other examples, data can be retrieved from a local memory, streamed over a network, or the like. An encoding device may encode and store data to memory, and/or a decoding device may retrieve and decode data from memory. In many examples, the encoding and decoding is performed by devices that do not communicate with one another, but simply encode data to memory and/or retrieve and decode data from memory.

Video encoder 20 and video decoder 30 each may be implemented as any of a variety of suitable circuitry, such as one or more microprocessors, digital signal processors (DSPs), application specific integrated circuits (ASICs), field programmable gate arrays (FPGAs), discrete logic, hardware, or any combinations thereof. When the techniques are implemented partially in software, a device may store instructions for the software in a suitable, non-transitory computer-readable storage medium and may execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device. A device including video encoder 20 and/or video decoder 30 may comprise an integrated circuit, a microprocessor, and/or a wireless communication device, such as a cellular telephone.

The JCT-VC is working on development of the HEVC standard. The HEVC standardization efforts are based on an evolving model of a video coding device, referred to as the HM. The HM presumes several additional capabilities of video coding devices relative to existing devices according to, for example, the ITU-T H.264/AVC standard. For example, whereas H.264 provides nine intra-prediction encoding modes, the HM may provide as many as thirty-three intra-prediction encoding modes.

In general, the working model of the HM describes that a video sequence includes a series of video frames or pictures. A GOP generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a coding unit (CU), which is described in greater detail below. The video blocks may have fixed or varying sizes, and may differ in size according to a specified coding standard.

In this disclosure, “N×N” and “N by N” may be used interchangeably to refer to the pixel dimensions of a video block in terms of vertical and horizontal dimensions (e.g., 16×16 pixels or 16 by 16 pixels). In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N. As used herein, the term “block” refers to any of a CU, PU, or TU, in the context of HEVC, or similar data structures in the context of other standards (e.g., macroblocks and sub-blocks thereof in H.264/AVC).

A video frame or picture may be divided into a sequence of treeblocks or largest coding units (LCU) that include both luma and chroma samples. An LCU may also be referred to as a coding tree unit (CTU). Syntax data within a bitstream may define a size for the LCU, which is a largest coding unit in terms of the number of pixels. A slice includes a number of consecutive treeblocks in coding order. A video frame or picture may be partitioned into one or more slices. Each treeblock may be split into CUs according to a quadtree (e.g., each treeblock may be split into four CUs). A CU may be formed from a luma coding block, two chroma coding blocks, and associated syntax data. In general, a quadtree data structure includes one node per CU, with a root node corresponding to the treeblock. If a CU is split into four sub-CUs, the node corresponding to the CU includes four leaf nodes, each of which corresponds to one of the sub-CUs. Thus, a treeblock may be split into four child nodes (e.g., CUs), and each child node may in turn be a parent node and be split into another four child nodes (e.g., sub-CUs).

Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs. If a CU is not split further, it is referred to as a leaf-CU. In this disclosure, four sub-CUs of a leaf-CU will also be referred to as leaf-CUs even if there is no explicit splitting of the original leaf-CU. For example, if a CU at 16×16 size is not split further, the four 8×8 sub-CUs will also be referred to as leaf-CUs although the 16×16 CU was never split.

A CU has a similar purpose as a macroblock of the H.264 standard, except that a CU does not have a size distinction. For example, as discussed above, a treeblock may be split into four child nodes (also referred to as sub-CUs), and each child node may in turn be a parent node and be split into another four child nodes. A final, unsplit child node, referred to as a leaf node of the quadtree, comprises a coding node, also referred to as a leaf-CU. Syntax data associated with a coded bitstream may define a maximum number of times a treeblock may be split, referred to as a maximum CU depth, and may also define a minimum size of the coding nodes, referred to as a smallest coding unit (SCU). This disclosure uses the term “block” to refer to any of a CU, prediction unit (PU), or transform unit (TU), in the context of HEVC, or similar data structures in the context of other standards (e.g., macroblocks and sub-blocks thereof in H.264/AVC).

A CU includes a coding node. A size of the CU corresponds to a size of the coding node and must be square in shape. The size of the CU may range from 8×8 pixels up to the size of the treeblock with a maximum of 64×64 pixels or greater.

Each CU may contain one or more PUs and one or more TUs. A PU describes a partition of a CU for the prediction of pixel values. The PUs may comprise syntax data describing a method or mode of generating predictive pixel data in the spatial domain (also referred to as the pixel domain). Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be square or non-square (e.g., rectangular, etc.) in shape.

In general, a PU represents a spatial area corresponding to all or a portion of the corresponding CU, and may include data for retrieving a reference sample for the PU. Moreover, a PU includes data related to the prediction process. For example, when the PU is intra-mode encoded, data for the PU may be included in a residual quadtree (RQT). The RQT may include data describing an intra-prediction mode for a TU corresponding to the PU. As another example, when the PU is inter-mode encoded, the PU may include data defining one or more motion vectors for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

As an example, the HM supports prediction in various PU sizes. Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

Following intra-predictive or inter-predictive coding using the PUs of a CU, video encoder 20 may calculate residual data for the TUs of the CU. The residual data may correspond to pixel differences between pixels of the unencoded (e.g., original) picture and prediction values corresponding to the PUs. A TU represents the units of a CU that are spatially transformed using a transform (e.g., a discrete cosine transform (DCT), an integer transform, a wavelet transform, or a conceptually similar transform). The TUs may comprise coefficients in the transform domain following application of the transform. Video encoder 20 may form the TUs including the residual data for the CU, and then transform the TUs to produce transform coefficients for the CU. Syntax data associated with a CU may describe, for example, partitioning of the CU into one or more TUs. In some aspects, the CU may be partitioned into one or more TUs according to a quadtree. A TU can be square or non-square (e.g., rectangular, etc.) in shape.

The TUs may be specified using an RQT (also referred to as a TU quadtree structure), as discussed above. For example, a split flag may indicate whether a leaf-CU is split into four TUs. Then, each TU may be split further into sub-TUs. When a TU is not split further, it may be referred to as a leaf-TU. Pixel difference values associated with the TUs may be transformed to produce transform coefficients, which may be quantized.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs.

Generally, for intra coding, all the leaf-TUs belonging to a leaf-CU share the same intra prediction mode. That is, the same intra-prediction mode is generally applied to calculate predicted values for all TUs of a leaf-CU. For intra coding, the video encoder 20 may calculate a residual value for each leaf-TU using the intra prediction mode, as a difference between the portion of the CU corresponding to the TU and the original block. A TU is not necessarily limited to the size of a PU. Thus, TUs may be the same size, larger, or smaller than a PU. For intra coding, a PU may be co-located with a corresponding leaf-TU for the same CU. In some examples, the maximum size of a leaf-TU may correspond to the size of the corresponding leaf-CU.

Following any transforms to produce transform coefficients, video encoder 20 may perform quantization of the transform coefficients. Quantization is a broad term intended to have its broadest ordinary meaning. In one embodiment, quantization refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

Following quantization, the video encoder 20 may scan the transform coefficients, producing a one-dimensional vector from the two-dimensional matrix including the quantized transform coefficients. The scan may be designed to place higher energy (and therefore lower frequency) coefficients at the front of the array and to place lower energy (and therefore higher frequency) coefficients at the back of the array. In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector (e.g., according to context-adaptive variable length coding (CAVLC), context-adaptive binary arithmetic coding (CABAC), syntax-based context-adaptive binary arithmetic coding (SBAC), Probability Interval Partitioning Entropy (PIPE) coding or another entropy encoding methodology). Video encoder 20 may also entropy encode syntax elements associated with the encoded video data for use by video decoder 30 in decoding the video data.

To perform CABAC, video encoder 20 may assign a context within a context model to a symbol to be transmitted. The context may relate to, for example, whether neighboring values of the symbol are non-zero or not. To perform CAVLC, video encoder 20 may select a variable length code for a symbol to be transmitted. Codewords in VLC may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination may be based on a context assigned to the symbol.

Video encoder 20 may further send syntax data, such as block-based syntax data, frame-based syntax data, and/or GOP-based syntax data, to video decoder 30 (e.g., in a frame header, a block header, a slice header, or a GOP header). The GOP-based syntax data may describe a number of frames in the respective GOP, and the frame-based syntax data may indicate an encoding/prediction mode used to encode the corresponding frame.

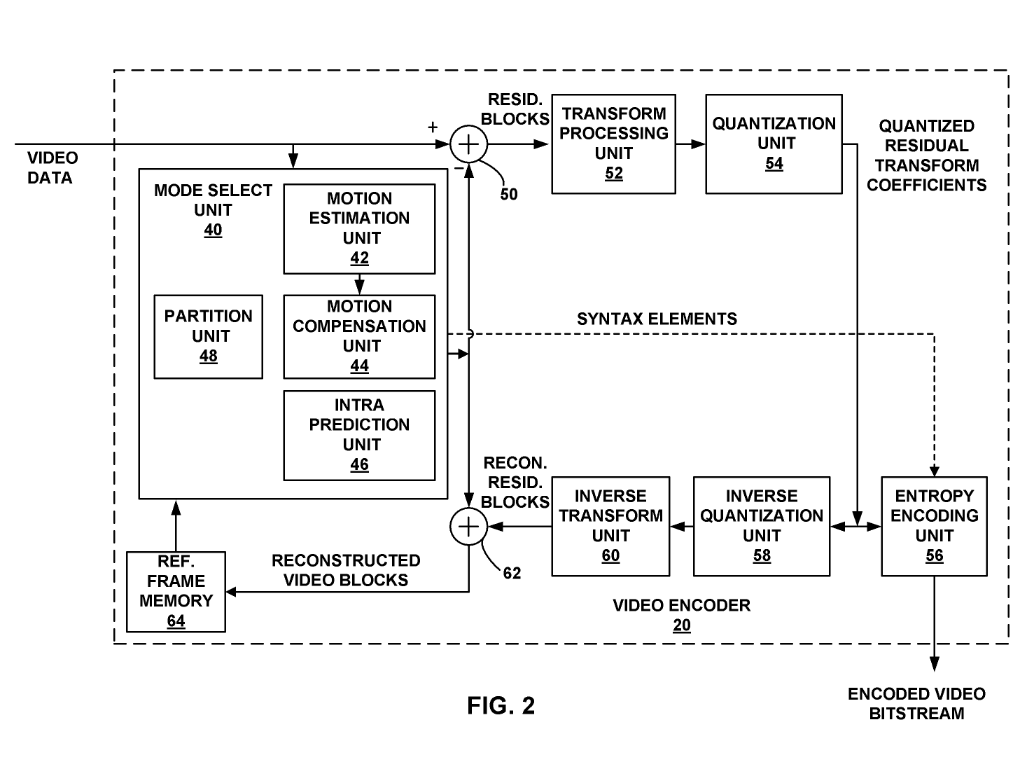

FIG. 2 is a block diagram illustrating an example of a video encoder that may implement techniques in accordance with aspects described in this disclosure. Video encoder 20 may be configured to perform any or all of the techniques of this disclosure. As one example, mode select unit 40 may be configured to perform any or all of the techniques described in this disclosure. However, aspects of this disclosure are not so limited. In some examples, the techniques described in this disclosure may be shared among the various components of video encoder 20. In some examples, in addition to or instead of, a processor (not shown) may be configured to perform any or all of the techniques described in this disclosure.

Video encoder 20 may perform intra- and inter-coding of video blocks within video slices. Intra coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based coding modes. Inter-modes, such as uni-directional prediction (P mode) or bi-prediction (B mode), may refer to any of several temporal-based coding modes.

As shown in FIG. 2, video encoder 20 receives a current video block within a video frame to be encoded. In the example of FIG. 2, video encoder 20 includes mode select unit 40, reference frame memory 64, summer 50, transform processing unit 52, quantization unit 54, and entropy encoding unit 56. Mode select unit 40, in turn, includes motion compensation unit 44, motion estimation unit 42, intra-prediction unit 46, and partition unit 48. For video block reconstruction, video encoder 20 also includes inverse quantization unit 58, inverse transform unit 60, and summer 62. A deblocking filter (not shown in FIG. 2) may also be included to filter block boundaries to remove blockiness artifacts from reconstructed video. If desired, the deblocking filter would typically filter the output of summer 62. Additional filters (in loop or post loop) may also be used in addition to the deblocking filter. Such filters are not shown for brevity, but if desired, may filter the output of summer 50 (as an in-loop filter).

During the encoding process, video encoder 20 receives a video frame or slice to be coded. The frame or slice may be divided into multiple video blocks. Motion estimation unit 42 and motion compensation unit 44 perform inter-predictive coding of the received video block relative to one or more blocks in one or more reference frames to provide temporal prediction. Intra-prediction unit 46 may alternatively perform intra-predictive coding of the received video block relative to one or more neighboring blocks in the same frame or slice as the block to be coded to provide spatial prediction. Video encoder 20 may perform multiple coding passes (e.g., to select an appropriate coding mode for each block of video data).

Moreover, partition unit 48 may partition blocks of video data into sub-blocks, based on an evaluation of previous partitioning schemes in previous coding passes. For example, partition unit 48 may initially partition a frame or slice into LCUs, and partition each of the LCUs into sub-CUs based on a rate-distortion analysis (e.g., rate-distortion optimization, etc.). In addition, partition unit 48 may be configured to perform partition derivation based on image segmentation, as described in greater detail above and below. Mode select unit 40 (e.g., partition unit 48) may further produce a quadtree data structure indicative of partitioning of an LCU into sub-CUs. As described above, leaf-node CUs of the quadtree may include one or more PUs and one or more TUs.

Mode select unit 40 may select one of the coding modes (e.g., intra or inter) based on error results, and provide the resulting intra- or inter-coded block to summer 50 to generate residual block data and to summer 62 to reconstruct the encoded block for use as a reference frame. Mode select unit 40 also provides syntax elements, such as motion vectors, intra-mode indicators, partition information, and other such syntax information, to entropy encoding unit 56.

Motion estimation unit 42 and motion compensation unit 44 may be highly integrated, but are illustrated separately for conceptual purposes. Motion estimation or the prediction of motion information, performed by motion estimation unit 42, is the process of generating motion vectors, which estimate motion for video blocks. A motion vector, for example, may indicate the displacement of a PU of a video block within a current video frame or picture relative to a predictive block within a reference frame (or other coded unit) relative to the current block being coded within the current frame (or other coded unit). A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in reference frame memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (e.g., List 0) or a second reference picture list (e.g., List 1), or a third reference picture list (e.g., List C), each of which identify one or more reference pictures stored in reference frame memory 64. Motion estimation unit 42 sends the calculated motion vector to entropy encoding unit 56 and/or motion compensation unit 44.

Motion compensation, performed by motion compensation unit 44, may involve fetching or generating the predictive block based on the motion vector determined by motion estimation unit 42. Again, motion estimation unit 42 and motion compensation unit 44 may be functionally integrated, in some examples. Upon receiving the motion vector for the PU of the current video block, motion compensation unit 44 may locate the predictive block to which the motion vector points in one of the reference picture lists. Summer 50 forms a residual video block by subtracting pixel values of the predictive block from the pixel values of the current video block being coded, forming pixel difference values, as discussed below. In some embodiments, motion estimation unit 42 performs motion estimation relative to luma components, and motion compensation unit 44 uses motion vectors calculated based on the luma components for both chroma components and luma components. Mode select unit 40 may also generate syntax elements associated with the video blocks and the video slice for use by video decoder 30 in decoding the video blocks of the video slice.

Intra-prediction unit 46 may intra-predict or calculate a current block, as an alternative to the inter-prediction performed by motion estimation unit 42 and motion compensation unit 44, in some embodiments. In particular, intra-prediction unit 46 may determine an intra-prediction mode to use to encode a current block. In some examples, intra-prediction unit 46 may encode a current block using various intra-prediction modes (e.g., during separate encoding passes) and intra-prediction unit 46 (or mode select unit 40, in some examples) may select an appropriate intra-prediction mode to use from the tested modes.

For example, intra-prediction unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bitrate (that is, a number of bits) used to produce the encoded block. Intra-prediction unit 46 may calculate ratios from the distortions and rates for the various encoded blocks to determine which intra-prediction mode exhibits the best rate-distortion value for the block.

After selecting an intra-prediction mode for a block, intra-prediction unit 46 may provide information indicative of the selected intra-prediction mode for the block to entropy encoding unit 56. Entropy encoding unit 56 may encode the information indicating the selected intra-prediction mode. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

As described above, video encoder 20 forms a residual video block by subtracting the prediction data provided by mode select unit 40 from the original video block being coded. Summer 50 represents the component or components that perform this subtraction operation. Transform processing unit 52 applies a transform, such as a DCT or a conceptually similar transform (e.g., wavelet transforms, integer transforms, sub-band transforms, etc.), to the residual block, producing a video block comprising residual transform coefficient values. The transform may convert the residual information from a pixel value domain to a transform domain, such as a frequency domain. Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy codes the quantized transform coefficients. For example, entropy encoding unit 56 may perform CAVLC, CABAC, SBAC, PIPE coding, or another entropy coding technique. In the case of context-based entropy coding, context may be based on neighboring blocks. Following the entropy coding by entropy encoding unit 56, the encoded bitstream may be transmitted to another device (e.g., video decoder 30) or archived for later transmission or retrieval.

Inverse quantization unit 58 and inverse transform unit 60 apply inverse quantization and inverse transformation, respectively, to reconstruct the residual block in the pixel domain (e.g., for later use as a reference block). Motion compensation unit 44 may calculate a reference block by adding the residual block to a predictive block of one of the frames of reference frame memory 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in reference frame memory 64. The reconstructed video block may be used by motion estimation unit 42 and motion compensation unit 44 as a reference block to inter-code a block in a subsequent video frame.

In another embodiment, not shown, a filter module may receive the reconstructed video block from the summer 62. The filter module may perform a deblocking operation to reduce blocking artifacts in the video block associated with the CU. After performing the one or more deblocking operations, the filter module may store the reconstructed video block of the CU in decoded picture buffer. The motion estimation unit 42 and the motion compensation unit 44 may use a reference picture that contains the reconstructed video block to perform inter prediction on PUs of subsequent pictures. In addition, the intra prediction unit 46 may use reconstructed video blocks in the decoded picture buffer to perform intra prediction on other PUs in the same picture as the CU. Thus, after the filter module applies a deblocking filter to the samples associated with an edge, a predicted video block may be generated based at least in part on the samples associated with the edge. The video encoder 20 may output a bitstream that includes one or more syntax elements whose values are based at least in part on the predicted video block.

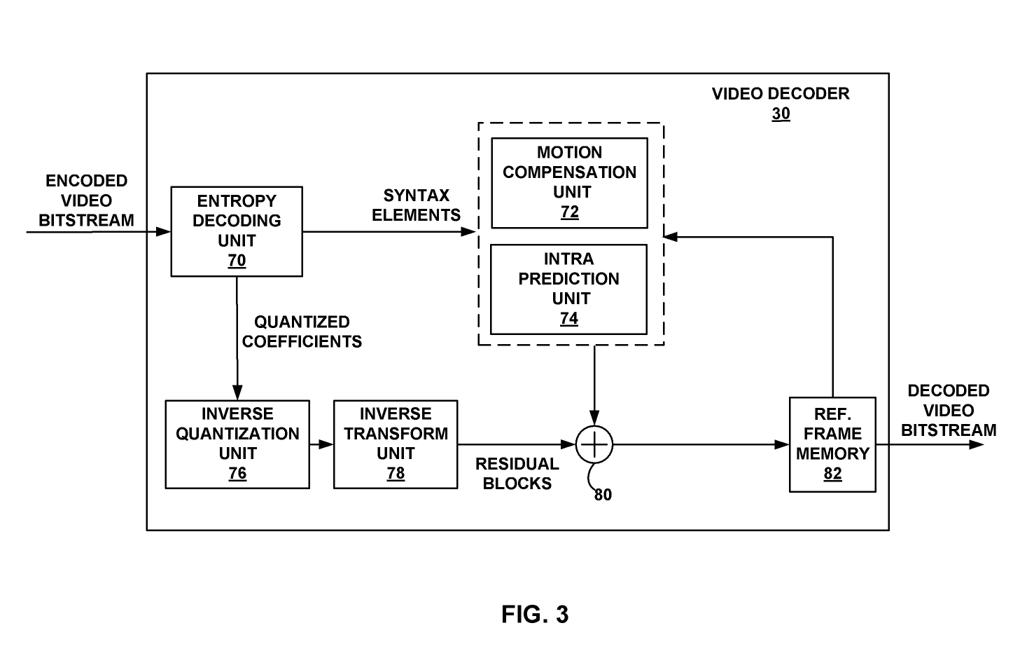

FIG. 3 is a block diagram illustrating an example of a video decoder that may implement techniques in accordance with aspects described in this disclosure. Video decoder 30 may be configured to perform any or all of the techniques of this disclosure. As one example, motion compensation unit 72 and/or intra prediction unit 74 may be configured to perform any or all of the techniques described in this disclosure. However, aspects of this disclosure are not so limited. In some examples, the techniques described in this disclosure may be shared among the various components of video decoder 30. In some examples, in addition to or instead of, a processor (not shown) may be configured to perform any or all of the techniques described in this disclosure.

In the example of FIG. 3, video decoder 30 includes an entropy decoding unit 70, motion compensation unit 72, intra prediction unit 74, inverse quantization unit 76, inverse transformation unit 78, reference frame memory 82, and summer 80. Video decoder 30 may, in some examples, perform a decoding pass generally reciprocal to the encoding pass described with respect to video encoder 20 (FIG. 2). Motion compensation unit 72 may generate prediction data based on motion vectors received from entropy decoding unit 70, while intra-prediction unit 74 may generate prediction data based on intra-prediction mode indicators received from entropy decoding unit 70.

During the decoding process, video decoder 30 receives an encoded video bitstream that represents video blocks of an encoded video slice and associated syntax elements from video encoder 20. Entropy decoding unit 70 of video decoder 30 entropy decodes the bitstream to generate quantized coefficients, motion vectors or intra-prediction mode indicators, and/or other syntax elements. Entropy decoding unit 70 forwards the motion vectors to and other syntax elements to motion compensation unit 72. Video decoder 30 may receive the syntax elements at the video slice level and/or the video block level.

When the video slice is coded as an intra-coded (I) slice, intra prediction unit 74 may generate prediction data for a video block of the current video slice based on a signaled intra prediction mode and data from previously decoded blocks of the current frame or picture. When the video frame is coded as an inter-coded (e.g., B, P or GPB) slice, motion compensation unit 72 produces predictive blocks for a video block of the current video slice based on the motion vectors and other syntax elements received from entropy decoding unit 70. The predictive blocks may be produced from one of the reference pictures within one of the reference picture lists. Video decoder 30 may construct the reference frame lists, List 0, List 1, and/or List C, using default construction techniques based on reference pictures stored in reference frame memory 82. Motion compensation unit 72 determines prediction information for a video block of the current video slice by parsing the motion vectors and other syntax elements, and uses the prediction information to produce the predictive blocks for the current video block being decoded. For example, motion compensation unit 72 uses some of the received syntax elements to determine a prediction mode (e.g., intra- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and/or other information to decode the video blocks in the current video slice.

Motion compensation unit 72 may also perform interpolation based on interpolation filters. Motion compensation unit 72 may use interpolation filters as used by video encoder 20 during encoding of the video blocks to calculate interpolated values for sub-integer pixels of reference blocks. In this case, motion compensation unit 72 may determine the interpolation filters used by video encoder 20 from the received syntax elements and use the interpolation filters to produce predictive blocks.

In addition, motion compensation unit 72 may be configured to perform partition derivation based on image segmentation, as described in greater detail above and below. As an example, the motion compensation unit 72 may be configured to perform partition derivation based on image segmentation using the syntax elements received from entropy decoding unit 70.

Inverse quantization unit 76 inverse quantizes (e.g., de-quantizes) the quantized transform coefficients provided in the bitstream and decoded by entropy decoding unit 70. The inverse quantization process may include use of a quantization parameter QPy calculated by video encoder 20 for each video block in the video slice to determine a degree of quantization and, likewise, a degree of inverse quantization that should be applied.

Inverse transform unit 78 applies an inverse transform (e.g., an inverse DCT), an inverse integer transform, or a conceptually similar inverse transform process, to the transform coefficients in order to produce residual blocks in the pixel domain.

In some cases, inverse transform unit 78 may apply a 2-dimensional (2-D) inverse transform (in both the horizontal and vertical direction) to the coefficients. According to the techniques of this disclosure, inverse transform unit 78 may instead apply a horizontal 1-D inverse transform, a vertical 1-D inverse transform, or no transform to the residual data in each of the TUs. The type of transform applied to the residual data at video encoder 20 may be signaled to video decoder 30 to apply an appropriate type of inverse transform to the transform coefficients.

After motion compensation unit 72 generates the predictive block for the current video block based on the motion vectors and other syntax elements, video decoder 30 forms a decoded video block by summing the residual blocks from inverse transform unit 78 with the corresponding predictive blocks generated by motion compensation unit 72. Summer 80 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in reference picture memory 82, which stores reference pictures used for subsequent motion compensation. Reference frame memory 82 also stores decoded video for later presentation on a display device, such as display device 32 of FIG. 1.

In another embodiment, not shown, after the summer 80 reconstructs the video block of the CU, a filter module may perform a deblocking operation to reduce blocking artifacts associated with the CU. After the filter module performs a deblocking operation to reduce blocking artifacts associated with the CU, the video decoder 30 may store the video block of the CU in a decoded picture buffer. The decoded picture buffer may provide reference pictures for subsequent motion compensation, intra prediction, and presentation on a display device, such as display device 32 of FIG. 1. For instance, the video decoder 30 may perform, based on the video blocks in the decoded picture buffer, intra prediction or inter prediction operations on PUs of other CUs.

In a typical video encoder, the frame of the original video sequence is partitioned into rectangular regions or blocks, which are encoded in Intra-mode (I-mode) or Inter-mode (P-mode). The blocks are coded using some kind of transform coding, such as DCT coding. However, pure transform-based coding may only reduce the inter-pixel correlation within a particular block, without considering the inter-block correlation of pixels, and may still produce high bit-rates for transmission. Current digital image coding standards may also exploit certain methods that reduce the correlation of pixel values between blocks.

In general, blocks encoded in P-mode are predicted from one of the previously coded and transmitted frames. The prediction information of a block may be represented by a two-dimensional (2D) motion vector. For the blocks encoded in I-mode, the predicted block is formed using spatial prediction from already encoded neighboring blocks within the same frame. The prediction error (e.g., the difference between the block being encoded and the predicted block) may be represented as a set of weighted basis functions of some discrete transform. The prediction error may also be referred to as residual data. The transform is typically performed on an 8×8 or 4×4 block basis. The weights (e.g., transform coefficients) are subsequently quantized. Quantization introduces loss of information and, therefore, quantized coefficients have lower precision than the originals.

Quantized transform coefficients, together with motion vectors and some control information, may form a complete coded sequence representation and are referred to as syntax elements. Prior to transmission from the encoder to the decoder, all syntax elements may be entropy coded so as to further reduce the number of bits needed for their representation.

In the decoder, the block in the current frame may be obtained by first constructing the block's prediction in the same manner as in the encoder and by adding to the prediction the compressed prediction error. The compressed prediction error may be found by weighting the transform basis functions using the quantized coefficients. The difference between the reconstructed frame and the original frame may be called reconstruction error.

In H.264/AVC, a video frame or slice is partitioned into square blocks of size 16×16 for encoding and decoding. Such blocks are called macroblocks. In the current HEVC, a video frame or slice is partitioned into square blocks of variable sizes for encoding and decoding. Such blocks may be called coding units or CUs in HEVC. For example, the size of a CU may be 64×64, 32×32, 16×16 or 8×8. Unlike a macroblock, a larger size CU can be split into a number of smaller size CUs. A non-split CU and a macroblock are similar to each other in terms of their concept and functionality.

Once a macroblock or a non-split CU is determined, the block can be further split into a number of partitions for prediction. Such a partition may also be referred as prediction unit or PU in HEVC.

FIG. 4 is a conceptual diagram that illustrates example partitioning modes. In an embodiment, in HEVC, the partition type for a given block may be symmetric (e.g., each vertical or horizontal half of the block is partitioned in the same way) or asymmetric (e.g., each vertical or horizontal half of the block is not partitioned in the same way) and at least one of several modes. FIG. 4 illustrates eight blocks 402, 404, 406, 408, 410, 412, 414, and 416. As shown in FIG. 4, block 402 has a partition type of mode 2N×2N, which is a symmetric partition. Block 404 has a partition type of mode N×N, which is a symmetric partition. Block 406 has a partition type of mode N×2N, which is a symmetric partition. Block 408 has a partition type of mode 2N×N, which is a symmetric partition. Block 410 has a partition type of mode nL×2N, which is an asymmetric partition. Block 412 has a partition type of mode nR×2N, which is an asymmetric partition. Block 414 has a partition type of mode 2N×nU, which is an asymmetric partition. Block 416 has a partition type of mode 2N×nD, which is an asymmetric partition.

In scalable video coding, video sequences may be coded in a layered structure including a base layer and a number of enhancement layers. Bitstreams from each layer may be multiplexed together into a single bitstream. Such a bitstream may be scalable in a sense that enhancement layer bitstreams, when decoded, can provide certain enhancements relative to the base layer. For example, such enhancements include spatial resolution, temporal resolution and/or quality. Correspondingly, such enhancements are also referred to as spatial scalability, temporal scalability, and SNR scalability, respectively. In an embodiment, the base layer can be decoded independently from the enhancement layers.

In some embodiments, regardless of a type of scalability, the goal of SVC may be to utilize inter-layer correlation to improve coding efficiency. Such inter-layer correlation may exist in different syntaxes (e.g., prediction modes, motion vectors, prediction residuals, etc.) of corresponding blocks in different layers.

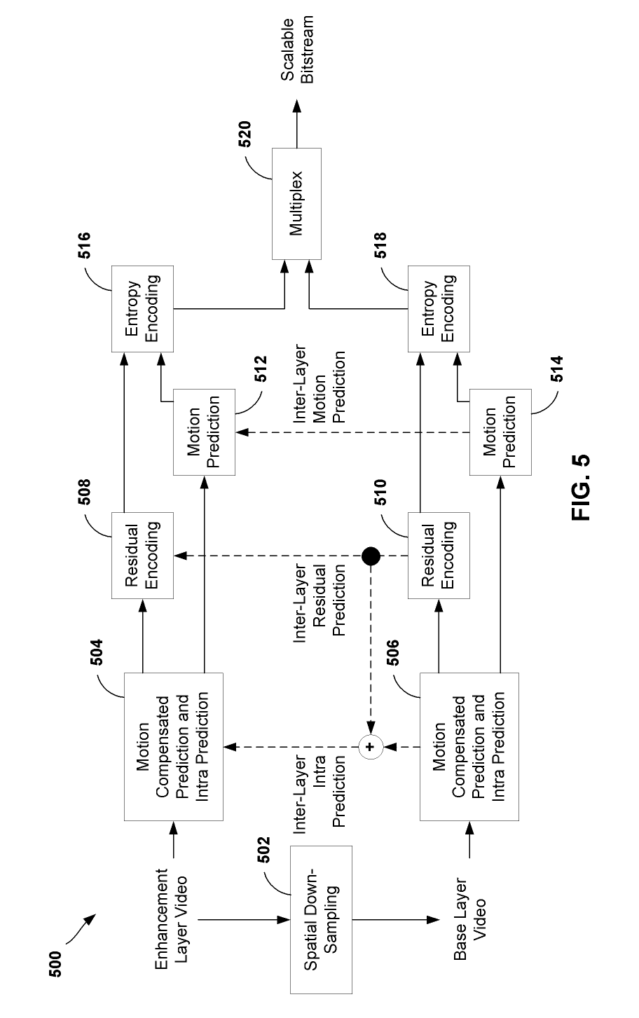

FIG. 5 is a block diagram of an example SVC encoder 500. As shown in FIG. 5, the SVC encoder 500 includes a spatial down-sampling unit 502, a motion compensated prediction and intra prediction unit 504, a motion compensated prediction and intra prediction unit 506, a residual coding unit 508, a residual coding unit 510, a motion prediction unit 512, a motion prediction unit 514, an entropy coding unit 516, an entropy coding unit 518, and a multiplex unit 520.

In an embodiment, the SVC encoder 500 receives enhancement layer video, which is transmitted to the spatial down-sampling unit 502 and/or the motion compensated prediction and intra prediction unit 504. The spatial down-sampling unit 502 may be configured to down-sample the enhancement layer video to generate base layer video. The base layer video may be transmitted to the motion compensated prediction and intra prediction unit 504.

The motion compensated prediction and intra prediction unit 506 may be configured to perform motion compensated prediction and/or intra prediction for one or more blocks in the base layer. The residual coding unit 510 may be configured to generate inter-layer residual prediction based on an output of the motion compensated prediction and intra prediction unit 506. The motion prediction unit 514 may be configured to generate inter-layer motion prediction based on an output of the motion compensated prediction and intra prediction unit 506. The entropy coding unit 516 may be configured to generate a video bitstream based on an output of the residual coding unit 508 and the motion prediction unit 512.

The motion compensated prediction and intra prediction unit 504 may be configured to perform motion compensated prediction and/or intra prediction for one or more blocks in the enhancement layer based at least in part on inter-layer intra prediction generated by the motion compensated prediction and intra prediction unit 506 and/or inter-layer residual prediction generated by the residual coding unit 510. The residual coding unit 508 may be configured to generate inter-layer residual prediction based on an output of the motion compensated prediction and intra prediction unit 504 and/or the inter-layer residual prediction generated by the residual coding unit 510. The motion prediction unit 512 may be configured to generate inter-layer motion prediction based on an output of the motion compensated prediction and intra prediction unit 504 and/or the inter-layer motion prediction generated by the motion prediction unit 514. The entropy coding unit 518 may be configured to generate a video bitstream based on an output of the residual coding unit 510 and the motion prediction unit 514.

In an embodiment, the multiplex 520 is configured to generate a scalable bitstream. The scalable bitstream may be based on an output of the entropy coding unit 516 and an output of the entropy coding unit 518.

To utilize such correlations, a number of coding tools were proposed in the past. For example, in the scalable extension of H.264/AVC, at least the following coding tools were defined:

1. Intra BL Mode

In this mode, the texture of a base layer reconstructed block is used as a predictor in predicting the corresponding enhancement layer block.

2. Residual Prediction

The prediction residual of a base layer block is used to predict the prediction residual of a corresponding enhancement layer block.

3. Mode Inheritance

The prediction mode (including partition mode) of a base layer block is used to predict the prediction mode of an enhancement layer block.

4. Motion Vector Prediction

The motion vectors of a base layer block are used to predict the motion vectors of an enhancement layer block.

In SVC, whether a layer is a base layer or an enhancement layer is all relative. Except for the first layer (e.g., the most bottom layer) and the last layer (e.g., the most top layer), any layer in between may be an enhancement layer for some lower layer(s), and at the same time may serve as a base layer for some higher layer(s).

Single loop decoding is a feature defined in H.264/SVC that enables enhancement layer decoding and reconstruction with a single loop of motion compensation. More specifically, to decode and reconstruct an enhancement layer block, the co-located block at a base layer for a current block at an enhancement layer is fully reconstructed only if it is coded in intra-prediction mode. If it is coded in inter-prediction mode, only its prediction residual is decoded. But the block may not be fully reconstructed because motion compensation is forbidden at the base layer.

In inter-layer mode inheritance, the partition mode of a co-located base layer block may be used to predict the partition mode of a current block at an enhancement layer. Such prediction of partition modes can be indicated through a flag sent from the encoder to the decoder for the block. For example, the flag may be generated by the partition unit 48 and included in the syntax elements generated by the mode select unit 40 of the encoder 20. In the decoder 30, the syntax elements extracted by the entropy decoding unit 70 may include the flag, and the flag may be analyzed by the motion compensation unit 72. When the flag has a certain value (e.g., one, etc.), the partition mode of a current block at the enhancement layer is derived based on the partition mode of its corresponding block at the base layer.

In an embodiment, a partition has a regular shape. As illustrated in FIG. 4, the partition modes all have regular shape prediction units. For example, the prediction units are either square or rectangular. Using rectangular shape prediction units may have the advantage of lower complexity. However, previous SVC coding schemes that use rectangular or square shape prediction units may result in a lower coding efficiency. In particular, a rectangular or square shape prediction may not precisely match an actual shape of an object, which often has a non-rectangular or irregular shape.

Accordingly, aspects of an SVC coding scheme are described herein that may improve coding efficiency. For example, in the scenario of SVC where a co-located block is already available at a base layer, deriving a prediction unit at an enhancement layer with a shape that more closely matches an actual shape of an object may be possible.

In accordance with the techniques of this disclosure, a partition of a current block at an enhancement layer is predicted or derived based on information of the current block's co-located base layer block, including partition mode, reconstructed video texture, motion information, etc. Furthermore, in accordance with the techniques of this disclosure, the derived partitions for a current block at the enhancement layer may not necessarily have regular shapes, such as a square or a rectangular. Instead, the partition shapes may be irregular. As described herein, the term “texture” may be used to refer to the reconstructed pixel values.

For example, a video coder (e.g., the video encoder 20 or the video decoder 30) may determine, based on information associated with a base layer block, a partitioning mode of an enhancement layer block. The video coder may be implemented by a video coding device. In this example, the base layer block may be in a base layer of the video data, the enhancement layer may be in an enhancement layer of the video data, and the base layer block and the enhancement layer block may be co-located (e.g., the base layer block may be located at a position in the base layer corresponding to a position of the enhancement layer block in the enhancement layer). In this example, the partitioning mode may partition the enhancement layer block into two or more non-rectangular partitions. The video coder may perform motion compensation for each of the non-rectangular partitions of the enhancement layer block. In this example, the information associated with the base layer block may include a partitioning mode of the base layer block, motion information of the base layer block, a reconstructed texture of the base layer block, and the like.

In some embodiments, partition derivation may be based on image segmentation of a base layer reconstructed texture. For example, the partition unit 48 of the video encoder 20 and/or the motion compensation unit 72 of the video decoder 30 may be configured to derive the partition of a current block at an enhancement layer based on segmentation of the reconstructed texture of the co-located block at the base layer. For example, image segmentation may be performed on top of the reconstructed texture of the co-located base layer block. Based on the segmentation, the co-located block can be partitioned by the partition unit 48 and/or the motion compensation unit 72 into a number of partitions whose shapes are often irregular. Such derived partitions may be used by the motion estimation unit 42, the motion compensation unit 44, and/or the motion compensation unit 72 for motion estimation and motion compensation for the current block at enhancement layer.

In an embodiment, regardless of what image segmentation method is used to derive the partition, as long as the video encoder 20 and the video decoder 30 use the same segmentation method, the same partition can be derived for both the video encoder 20 and the video decoder 30. For example, a simple segmentation method can be designed as follows. Based on the reconstructed base layer block, a threshold value can be calculated or determined. For example, the threshold value can be determined as half of the maximum possible pixel value. For an 8-bit pixel value, the threshold may be 127. The threshold value can also be calculated as the median value or average value of all the pixel values in the block. Once a threshold value has been determined, based on the threshold value, pixels with values lower than or equal to the threshold may be classified into one partition, while other pixels with values larger than the threshold value may be classified into another partition. In this case, there is no need to signal any data from the video encoder 20 to the video decoder 30 regarding how the image segmentation operation is performed. In one embodiment, a different threshold may be signaled for each luma coding block and chroma coding block in a prediction unit. In another embodiment, a single threshold may be signaled for each luma and chroma coding block in a coding unit.

For example, the non-rectangular partitions of an enhancement layer block may include a first partition and a second partition. In this example, a video coder may determine a partitioning mode of the enhancement layer block by classifying into the first partition pixels of the base layer block having values that exceed a threshold. The video coder may classify into the second partition pixels of the base layer block having values that do not exceed the threshold.

The segmentation method described herein is just one example. In other embodiments, other different segmentation methods may also be used.

In another embodiment, some parameters related to the segmentation method may be signaled from the video encoder 20 to the video decoder 30. For example, the partition unit 48 may be configured to determine the threshold value described in the example above. The mode select unit 40 (e.g., the partition unit 48) may then be configured to signal the threshold value to the video decoder 30 (e.g., via the syntax elements generated by the mode select unit 40). Signaling such parameters may incur additional signaling overhead. However, signaling such parameters may enable more precise image segmentation so that the derived partition may better match the actual shape of the object.

In other embodiments, partition derivation is based on image segmentation of a base layer prediction residual. For example, for a current block at an enhancement layer with a co-located inter-predicted block at a base layer, the partition unit 48 of the video encoder 20 and/or the motion compensation unit 72 of the video decoder 30 may be configured to perform image segmentation on the reconstructed prediction residual of the base layer block. Because there may be a larger prediction residual along object boundaries or edges, the amplitude of the prediction residual may be a good indicator of where the object boundaries are located. This may be especially useful in the case of single loop decoding because only intra coded blocks at the base layer may be fully reconstructed (e.g., only the prediction residual for inter-predicted blocks may be reconstructed and available for use).

In still other embodiments, where partition derivation is based on image segmentation of base layer prediction residual, the partition unit 48 of the video encoder 20 and/or the motion compensation unit 72 of the video decoder 30 may be configured to perform image segmentation based on both reconstructed pixel values and reconstructed prediction residuals derived from a co-located base layer block. The segmentation results may be used to derive a partition for the current block at the enhancement layer. For example, a video coder may determine a partitioning of an enhancement layer block based on information associated with a co-located base layer block. In this example, the information associated with the co-located base layer block may include a reconstructed residual of the base layer block and/or reconstructed pixel values of the base layer block.

In further embodiments, conditional enabling of image segmentation based on partition derivation may be used. In an embodiment, the partition unit 48 and/or the motion compensation unit 72 may be configured to conditionally enable the partition of a current block at an enhancement layer based on certain conditions of the co-located base layer block. For example, a video coder, such as the video encoder 20 (e.g., the partition unit 48) or the video decoder 30 (e.g., the motion compensation unit 72), may determine whether to determine the partitioning mode of an enhancement layer block based on information associated with a co-located base layer block.

In some aspects, a base layer partition mode can be used to conditionally enable the inter-layer partition derivation based on image segmentation. If the co-located base layer block has only one partition (e.g., having a 2N×2N mode), the image segmentation based partition derivation may not be an option for a current block at the enhancement layer. As a result, the syntax related to this mode may not need to be signaled to the video decoder 30. Otherwise, the image segmentation based partition derivation may be a valid mode for the current block, with syntax related to this mode signaled to the video decoder 30. In this way, a video coder may determine whether to determine the partitioning mode of an enhancement layer block by determining, based on a partitioning mode of a co-located base layer block, whether to determine the partitioning mode of the enhancement layer block based on the information associated with the base layer block.

In still other embodiments, motion vectors from co-located base layer blocks may be used to conditionally enable the inter-layer partition derivation based on image segmentation. For example, the partition unit 48 and/or the motion compensation unit 72 may be configured to enable the partition mode derivation only when the co-located base layer block has more than one partition and the motion vectors in those partitions are sufficiently different. For example, the partition unit 48 and/or the motion compensation unit 72 can be configured to define a threshold value to measure the difference between motion vectors. When the difference between motion vectors is larger than the threshold, the image segmentation based partition derivation may be a valid mode for the current block at the enhancement layer. If the image segmentation based partition derivation is a valid mode, syntax related to this mode may be signaled to the video decoder 30.

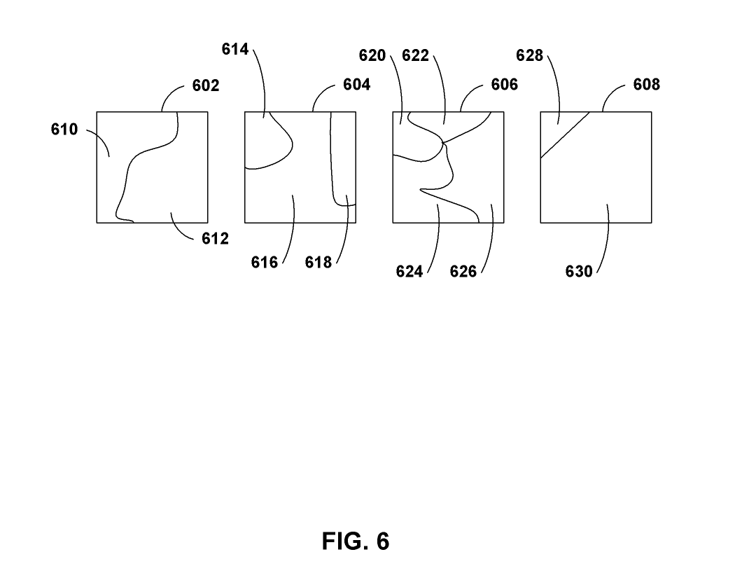

FIG. 6 is another conceptual diagram that illustrates example partitioning modes. FIG. 6 illustrates four blocks 602, 604, 606, and 608 that include regular and irregular partition shapes based on image segmentation. For example, blocks 602, 604, 606, and/or 608 may be partitioned by the partition unit 48 and/or the motion compensation unit 72 based on a partitioning mode of the co-located base layer block, motion information of the co-located base layer block, a reconstructed video texture of the co-located base layer block, a reconstructed prediction residual of the co-located base layer block, and/or reconstructed pixel values of the co-located base layer block, as described herein.

Block 602 may include a first partition 610 and a second partition 612. Block 604 may include a first partition 614, a second partition 616, and a third partition 618. Block 606 may include a first partition 620, a second partition 622, a third partition 624, and a fourth partition 626. Each of partitions 610, 612, 614, 616, 618, 620, 622, 624, and 626 are of an irregular shape. The irregular shape may be determined based on the shape(s) of object(s) illustrated in the respective blocks 602, 604, and/or 606. For example, an object in a block may be darker, lighter, and/or of a different color than other items illustrated in the block. In other words, the values of the pixels that represent the object may be different than the values of the pixels that represent other items in the block. Thus, the object and the object's shape may be identified in the block based on pixels in the block that are greater than a threshold value, greater than or equal to a threshold value, less than a threshold value, and/or less than or equal to a threshold value. The boundaries of the partitions may then correspond to an edge, contour, and/or boundary of the object.

Block 608 may include a first partition 628 and a second partition 630. Each of partitions 628 and 630 are of a regular shape. Like with the irregularly shaped partitions of block 602, 604, and 606, the regular shape may be determined based on the shape(s) of object(s) illustrated in block 608.

In an embodiment, pixels in the block may be classified into a partition based on a comparison with the threshold value. For example, pixels may be classified into partition 610 if they exceed the threshold value, whereas pixels may be classified into partition 612 if they do not exceed the threshold value. The same may apply for the partitions in blocks 604, 606, and/or 608. Multiple threshold values may be used so that a block may include multiple partitions (e.g., if there are multiple objects in an image).

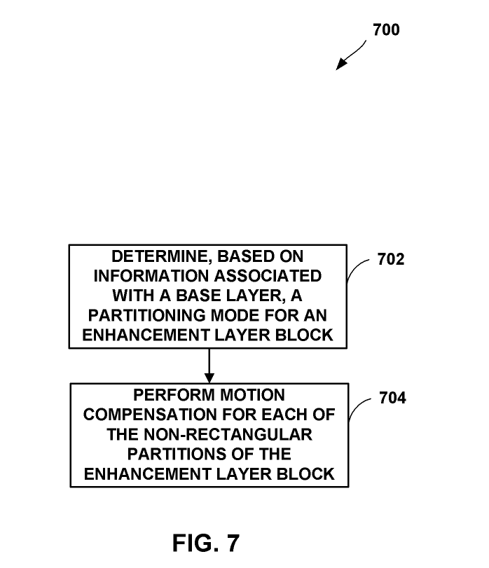

FIG. 7 is a flowchart illustrating an example method for coding video data according to aspects of this disclosure. The process 700 may be performed by an encoder (e.g., the encoder as shown in FIG. 2) or a decoder (e.g., the decoder as shown in FIG. 3).

At block 702, the process 700 may determine, based on information associated with a base layer block, a partitioning mode of an enhancement layer block. In an embodiment, a base layer of the video data may comprise the base layer block. In a further embodiment, an enhancement layer of the video data may comprise the enhancement layer block. In a further embodiment, the base layer block may be located at a position in the base layer corresponding to a position of the enhancement layer block in the enhancement layer. In a further embodiment, the partitioning mode may indicate that the enhancement layer block is to be partitioned into two or more non-rectangular partitions. At block 704, the process 700 may perform motion compensation for each of the non-rectangular partitions of the enhancement layer block.

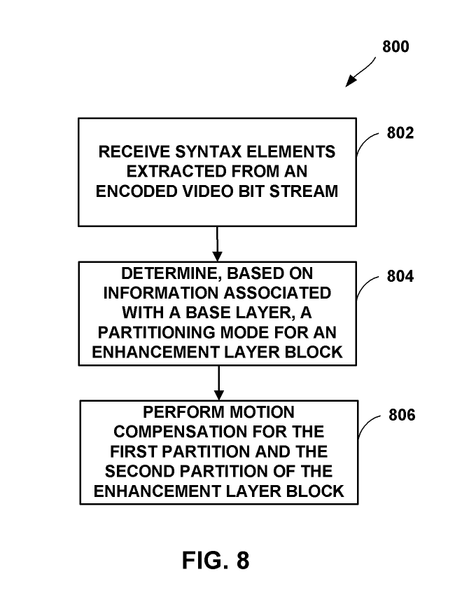

FIG. 8 is a flowchart illustrating an example method for decoding video data according to aspects of this disclosure. The process 800 may be performed by a decoder (e.g., the decoder as shown in FIG. 3).

At block 802, the process 800 may receive syntax elements extracted from an encoded video bit stream. In an embodiment, the encoded video bit stream comprises information associated with a base layer block.

At block 804, the process 800 may determine, based on the information associated with the base layer block, a partitioning mode of an enhancement layer block. In an embodiment, a base layer of the video data may comprise the base layer block. In a further embodiment, an enhancement layer of the video data may comprise the enhancement layer block. In a further embodiment, the base layer block may be located at a position in the base layer corresponding to a position of the enhancement layer block in the enhancement layer. In a further embodiment, the partitioning mode may indicate that the enhancement layer block is to be partitioned into a first partition and a second partition. In a further embodiment, pixels of the base layer block are classified into the first partition if a value of the respective pixel exceeds a threshold and are classified into the second partition if a value of the respective pixel does not exceed the threshold. At block 806, the process 800 may perform motion compensation for the first partition and the second partition of the enhancement layer block.

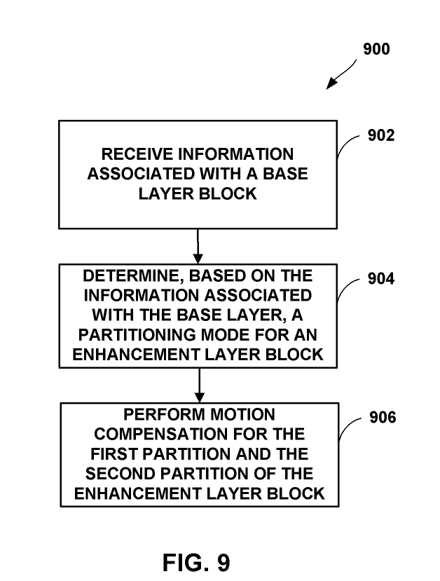

FIG. 9 is a flowchart illustrating an example method for encoding video data according to aspects of this disclosure. The process 900 may be performed by a encoder (e.g., the encoder as shown in FIG. 2).

At block 902, the process 900 may receive information associated with a base layer block. At block 904, the process 900 may determine, based on the information associated with the base layer block, a partitioning mode of an enhancement layer block. In an embodiment, a base layer of the video data may comprise the base layer block. In a further embodiment, an enhancement layer of the video data may comprise the enhancement layer block. In a further embodiment, the base layer block may be located at a position in the base layer corresponding to a position of the enhancement layer block in the enhancement layer. In a further embodiment, the partitioning mode may indicate that the enhancement layer block is to be partitioned into a first partition and a second partition. In a further embodiment, pixels of the base layer block are classified into the first partition if a value of the respective pixel exceeds a threshold and are classified into the second partition if a value of the respective pixel does not exceed the threshold. At block 906, the process 900 may perform motion compensation for the first partition and the second partition of the enhancement layer block.

In some embodiments, a device may include means for determining, based on information associated with a base layer block, a partitioning mode of an enhancement layer block. In an embodiment, the means for determining, based on information associated with a base layer block, a partitioning mode of an enhancement layer block may be configured to perform one or more of the functions discussed above with respect to block 704, 804, and/or 904. In further embodiments, the device may include means for performing motion compensation for each of the non-rectangular partitions of the enhancement layer block. In an embodiment, the means for performing motion compensation for each of the non-rectangular partitions of the enhancement layer block may be configured to perform one or more of the functions discussed above with respect to block 706, 806, and/or 906. In a further embodiment, the means for determining, based on information associated with a base layer block, a partitioning mode of an enhancement layer block may comprise a processor (e.g., the partition unit 48, the motion compensation unit 72, etc.). In a further embodiment, the means for performing motion compensation for each of the non-rectangular partitions of the enhancement layer block may comprise a processor (e.g., the partition unit 48, the motion compensation unit 72, etc.).

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Various examples have been described. These and other examples are within the scope of the following claims.

What is claimed is:

1. A method for decoding video data, the method comprising:
receiving syntax elements extracted from an encoded video bit stream, wherein the syntax elements comprise information associated with a base layer block of a base layer of the video data;
determining, based on the information associated with the base layer block, a partitioning mode of an enhancement layer block of an enhancement layer of the video data, wherein the base layer block is located at a position in the base layer corresponding to a position of the enhancement layer block in the enhancement layer, wherein the partitioning mode indicates that the enhancement layer block is to be partitioned into a first partition and a second partition, and wherein pixels of the base layer block are classified into the first partition if a value of the respective pixel exceeds a threshold and are classified into the second partition if a value of the respective pixel does not exceed the threshold; and
performing motion compensation for the first partition and the second partition of the enhancement layer block.

2. The method of claim 1, wherein the information associated with the base layer block includes at least one of a partitioning mode of the base layer block, motion information of the base layer block, a reconstructed video texture of the base layer block, a reconstructed prediction residual of the base layer block, or reconstructed pixel values of the base layer block.

3. The method of claim 1, wherein the first partition and the second partition are at least one of rectangular or non-rectangular.

4. The method of claim 1, further comprising receiving from the video bit stream a syntax element that signals the threshold.

5. The method of claim 4, further comprising:
decoding the video bit stream; and
determining prediction information for the base layer block based on the syntax element.

6. The method of claim 1, further comprising determining, based on conditions of the base layer block, whether to determine the partitioning mode of the enhancement layer block based on the information associated with the base layer block.

7. The method of claim 6, wherein determining whether to determine the partitioning mode of the enhancement layer block comprises determining, based on a partitioning mode of the base layer block, whether to determine the partitioning mode of the enhancement layer block based on the information associated with the base layer block.

8. The method of claim 6, wherein determining whether to determine the partitioning mode of the enhancement layer block comprises determining, based on motion vectors of the base layer block, whether to determine the partitioning mode of the enhancement layer block based on the information associated with the base layer block.

9. The method of claim 1, further comprising partitioning the enhancement layer block into the first partition and the second partition based upon said determining the partitioning mode.

10. A method for encoding video data, the method comprising:
receiving information associated with a base layer block of a base layer of the video data;
determining, based on the information associated with the base layer block, a partitioning mode of an enhancement layer block of an enhancement layer of the video data, wherein the base layer block is located at a position in the base layer corresponding to a position of the enhancement layer block in the enhancement layer, wherein the partitioning mode indicates that the enhancement layer block is to be partitioned into a first partition and a second partition, and wherein pixels of the base layer block are classified into the first partition if a value of the respective pixel exceeds a threshold and are classified into the second partition if a value of the respective pixel does not exceed the threshold; and
performing motion compensation for the first partition and the second partition of the enhancement layer block.

11. The method of claim 10, wherein the information associated with the base layer block includes at least one of a partitioning mode of the base layer block, motion information of the base layer block, a reconstructed video texture of the base layer block, a reconstructed prediction residual of the base layer block, or reconstructed pixel values of the base layer block.

12. The method of claim 10, wherein the first partition and the second partition are at least one of rectangular or non-rectangular.

13. The method of claim 10, further comprising adding to a bit stream a syntax element that signals the threshold.

14. The method of claim 13, further comprising:
generating the syntax element that signals the threshold; and
entropy coding the syntax element.

15. The method of claim 10, further comprising determining, based on conditions of the base layer block, whether to determine the partitioning mode of the enhancement layer block based on the information associated with the base layer block.

16. The method of claim 15, wherein determining whether to determine the partitioning mode of the enhancement layer block comprises determining, based on a partitioning mode of the base layer block, whether to determine the partitioning mode of the enhancement layer block based on the information associated with the base layer block.

17. The method of claim 16, wherein determining whether to determine the partitioning mode of the enhancement layer block comprises determining, based on motion vectors of the base layer block, whether to determine the partitioning mode of the enhancement layer block based on the information associated with the base layer block.

18. The method of claim 1, further comprising partitioning the enhancement layer block into the first partition and the second partition based upon said determining the partitioning mode.

19. An apparatus configured to code video data, the apparatus comprising:
a memory configured to store the video data, wherein the video data comprises a base layer and an enhancement layer, wherein the base layer comprises a base layer block, wherein the enhancement layer comprises an enhancement layer block, and wherein the base layer block is located at a position in the base layer corresponding to a position of the enhancement layer block in the enhancement layer; and
a processor in communication with the memory, the processor configured to:
determine, based on information associated with the base layer block, a partitioning mode of the enhancement layer block, wherein the partitioning mode indicates that the enhancement layer block is to be partitioned into a first partition and a second partition, and wherein pixels of the base layer block are classified into the first partition if a value of the respective pixel exceeds a threshold and are classified into the second partition if a value of the respective pixel does not exceed the threshold; and
perform motion compensation for the first partition and the second partition of the enhancement layer block.

20. The apparatus of claim 19, wherein the information associated with the base layer block includes at least one of a partitioning mode of the base layer block, motion information of the base layer block, a reconstructed video texture of the base layer block, a reconstructed prediction residual of the base layer block, or reconstructed pixel values of the base layer block.

21. The apparatus of claim 19, wherein the first partition and the second partition are at least one of rectangular or non-rectangular.

22. The apparatus of claim 19, wherein the processor is configured to add to a bit stream a syntax element that signals the threshold.

23. The apparatus of claim 22, wherein the processor is configured to entropy encode the syntax element so as to generate an encoded bitstream.

24. The apparatus of claim 21, wherein the processor is further configured to receive from an encoded bit stream a syntax element that signals the threshold, to determine prediction information for the base layer block based on the syntax element, and to decode the base layer block based on the determined prediction information.

25. The apparatus of claim 19, wherein the processor is further configured to determine, based on conditions of the base layer block, whether to determine the partitioning mode of the enhancement layer block based on the information associated with the base layer block.

26. The apparatus of claim 25, wherein the processor is further configured to determine, based on a partitioning mode of the base layer block, whether to determine the partitioning mode of the enhancement layer block based on the information associated with the base layer block.

27. The apparatus of claim 25, wherein the processor is further configured to determine, based on motion vectors of the base layer block, whether to determine the partitioning mode of the enhancement layer block based on the information associated with the base layer block.

28. The apparatus of claim 19, wherein the processor is further configured to partition the enhancement layer block into the first partition and the second partition based upon said determination of the partitioning mode.

29. A non-transitory computer readable medium having stored thereon code that, when executed, causes an apparatus to:
determine, based on information associated with a base layer block of a base layer of video data, a partitioning mode of an enhancement layer block of an enhancement layer of the video data, wherein the base layer block is located at a position in the base layer corresponding to a position of the enhancement layer block in the enhancement layer, wherein the partitioning mode indicates that the enhancement layer block is to be partitioned into a first partition and a second partition, and wherein pixels of the base layer block are classified into the first partition if a value of the respective pixel exceeds a threshold and are classified into the second partition if a value of the respective pixel does not exceed the threshold; and
perform motion compensation for each of the first partition and the second partition of the enhancement layer block.

30. The medium of claim 29, wherein the information associated with the base layer block includes at least one of a partitioning mode of the base layer block, motion information of the base layer block, a reconstructed video texture of the base layer block, a reconstructed prediction residual of the base layer block, or reconstructed pixel values of the base layer block.

31. The medium of claim 29, wherein the first partition and the second partition are at least one of rectangular or non-rectangular.

32. The medium of claim 29, further comprising code that, when executed, causes an apparatus to determine, based on conditions of the base layer block, whether to determine the partitioning mode of the enhancement layer block based on the information associated with the base layer block.

33. The medium of claim 32, further comprising code that, when executed, causes an apparatus to determine, based on a partitioning mode of the base layer block, whether to determine the partitioning mode of the enhancement layer block based on the information associated with the base layer block.

34. The medium of claim 33, further comprising code that, when executed, causes an apparatus to determine, based on motion vectors of the base layer block, whether to determine the partitioning mode of the enhancement layer block based on the information associated with the base layer block.

35. A video coding device that codes video data, the video coding device comprising:
means for determining, based on information associated with a base layer block of a base layer of the video data, a partitioning mode of an enhancement layer block of an enhancement layer of the video data, wherein the base layer block is located at a position in the base layer corresponding to a position of the enhancement layer block in the enhancement layer, wherein the partitioning mode indicates that the enhancement layer block is to be partitioned into a first partition and a second partition, and wherein pixels of the base layer block are classified into the first partition if a value of the respective pixel exceeds a threshold and are classified into the second partition if a value of the respective pixel does not exceed the threshold; and
means for performing motion compensation for each of the non-rectangular partitions of the enhancement layer block.

36. The video coding device of claim 35, wherein the information associated with the base layer block includes at least one of a partitioning mode of the base layer block, motion information of the base layer block, a reconstructed video texture of the base layer block, a reconstructed prediction residual of the base layer block, or reconstructed pixel values of the base layer block.

37. The video coding device of claim 35, wherein the first partition and the second partition are at least one of rectangular or non-rectangular.

38. The video coding device of claim 35, further comprising means for determining, based on conditions of the base layer block, whether to determine the partitioning mode of the enhancement layer block based on the information associated with the base layer block.

39. The video coding device of claim 38, wherein the means for determining whether to determine the partitioning mode of the enhancement layer block comprises means for determining, based on a partitioning mode of the base layer block, whether to determine the partitioning mode of the enhancement layer block based on the information associated with the base layer block.

40. The video coding device of claim 38, wherein the means for determining whether to determine the partitioning mode of the enhancement layer block comprises means for determining, based on motion vectors of the base layer block, whether to determine the partitioning mode of the enhancement layer block based on the information associated with the base layer block.
